(19) United States
(12) Patent Application Publication
(10) Pub. No.: US 2025/0356350 A1
(43) Pub. Date: Nov. 20, 2025

(54) METHOD AND SYSTEM FOR TRANSACTION RISK SCREENING

(71) Applicant: Visa International Service Association, San Francisco, CA (US)

(72) Inventors: Daniel Villar, Doral, FL (US); Gustavo de Carvalho, Sao Carlos (BR); Jenny Ramirez, Miami, FL (US); Barbara E. Patterson, South San Francisco, CA (US); Ricardo Collada, Miami, FL (US); Carlos Bragatto, Boituva (BR); Glenn Leon Powell, South Jordan, UT (US)

(73) Assignee: Visa International Service Association, San Francisco, CA (US)

(21) Appl. No.: 18/664,122

(22) Filed: May 14, 2024

(51) Int. Cl. G06Q 20/40

(52) U.S. Cl. CPC G06Q 20/401

(57) ABSTRACT

A computer-implemented method is disclosed. The method includes using a payment network to receive a transmission from a risk-screening module, generate an authentication message based on a prescreened status of the payment network, transmit a communication to the risk-screening module, receive from an acquirer an authorization request for the payment transaction where the authorization request is by the merchant, receive from an acquirer the authentication message, detect the prescreened status of the payment transaction, and associate the authorization request with an indicator of the prescreened status of the payment transaction based on the authentication message. The transmission includes a request for the authentication message for a payment transaction with a merchant associated with the risk-screening module. The payment transaction includes the prescreened status. The communication includes the authentication message. The detecting of the prescreened status of the payment transaction is based on the authentication message.

### TECHNICAL FIELD

The following disclosure relates generally to methods and system for evaluating transactions.

### SUMMARY

In various embodiments, a computer-implemented method is disclosed. The method includes using a payment network to receive a transmission from a risk-screening module, generate an authentication message based on a prescreened status of the payment network, transmit a communication to the risk-screening module, receive from an acquirer an authorization request for the payment transaction where the authorization request is by the merchant, receive from an acquirer the authentication message, detect the prescreened status of the payment transaction, and associate the authorization request with an indicator of the prescreened status of the payment transaction based on the authentication message. The transmission includes a request for the authentication message for a payment transaction with a merchant associated with the risk-screening module. The payment transaction includes the prescreened status. The communication includes the authentication message. The detecting of the prescreened status of the payment transaction is based on the authentication message.

In various embodiments, a computer-implemented method is disclosed. The method includes using a risk-screening module to receive a risk-evaluation request regarding a payment transaction with a merchant, determine a risk value associated with the payment transaction, approve the payment transaction based on the risk value and a corresponding threshold, transmit to the merchant the approval of the payment transaction, request an authentication message from a payment network based on the approving of the payment transaction, and transmit the authentication message to the merchant to initiate an authorization request for the payment transaction with the authentication message.

In various embodiments, a transaction risk-screening system is disclosed. The transaction risk-screening system includes a payment network. The payment network includes a cryptogram database, a cryptogram generator, and an application programming interface (API). The payment network is to receive a transmission from a risk-screening module, generate a cryptogram based on a prescreened status of the payment transaction, store the cryptogram in the cryptogram database, transmit a communication to the risk-screening module, receive from an acquirer an authorization request for the payment transaction where the authorization request is by the merchant, receive from an acquirer the cryptogram, validate the cryptogram based on the cryptogram database to identify the prescreened status of the payment transaction, and flag the authorization request to indicate the prescreened status of the payment transaction. The receiving of the transmission occurs via the API. The transmission includes a request for a cryptogram for a payment transaction with a merchant associated with the risk-screening module. The payment transaction includes a prescreened status. The generation of the cryptogram occurs by the cryptogram generator. The transmission of the communication occurs via the API. The communication includes the cryptogram. The receipt from the acquirer occurs by the payment network.

### DESCRIPTION

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

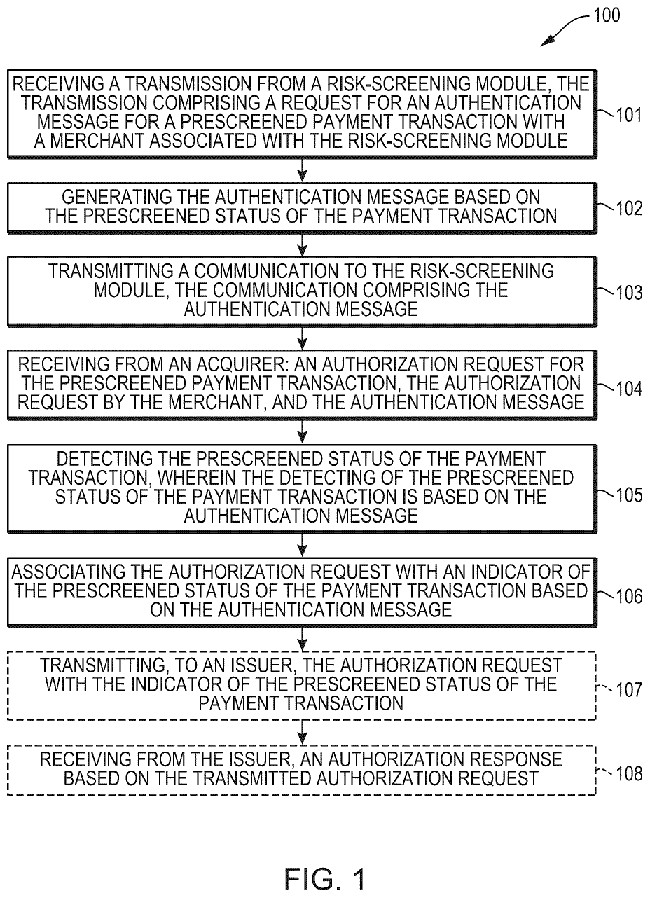

FIG. 1 is a flow diagram illustrating a method for processing payment transactions, according to at least one aspect of the present disclosure.

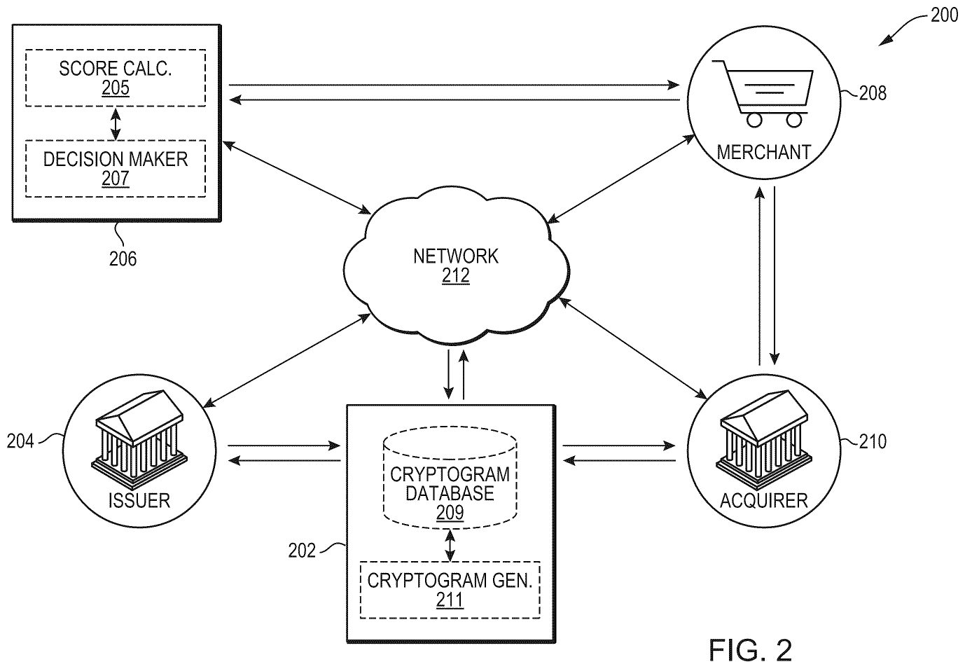

FIG. 2 illustrates a system for processing payment transactions, according to at least one aspect of the present disclosure.

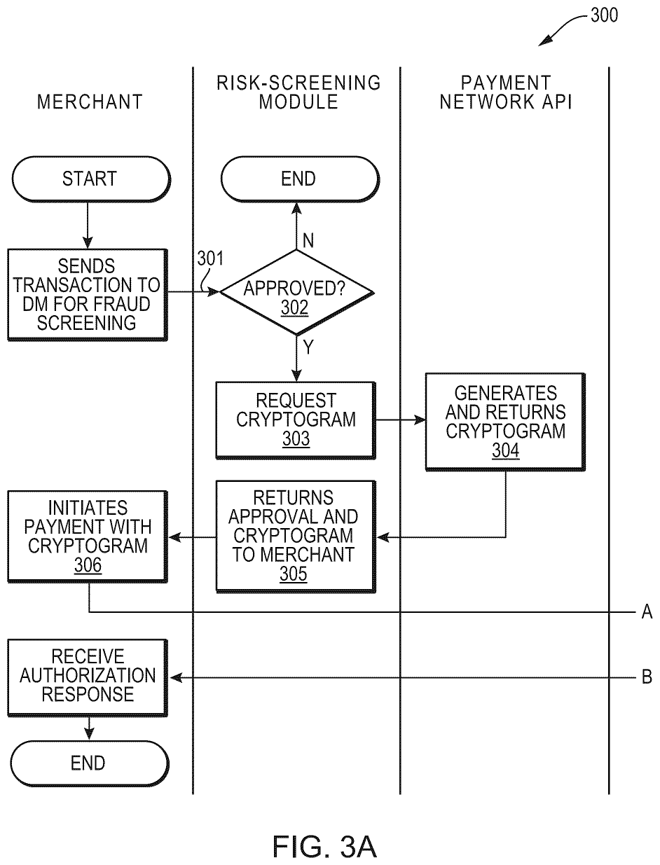

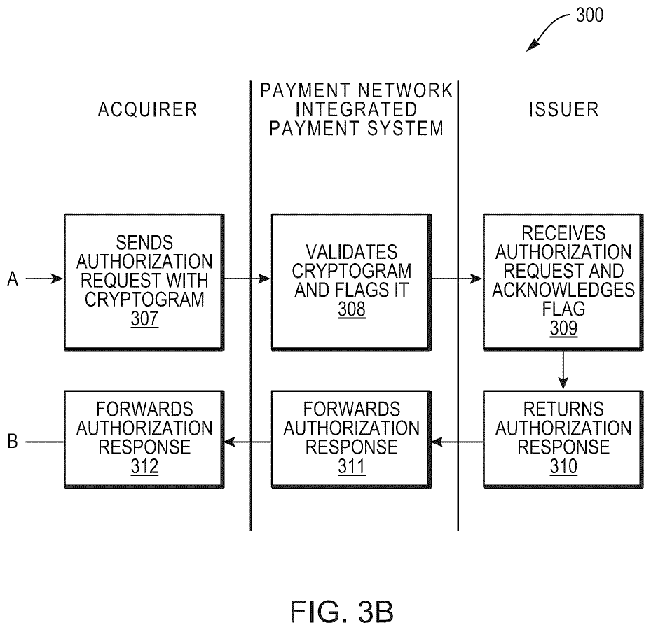

FIGS. 3A and 3B illustrate interactions between components of the system of FIG. 2, according to at least one aspect of the present disclosure.

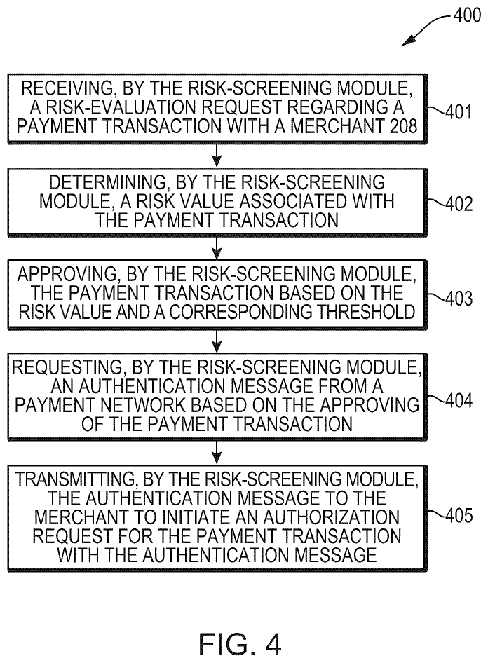

FIG. 4 is a flow diagram illustrating a method for initiating payment transactions, according to at least one aspect of the present disclosure.

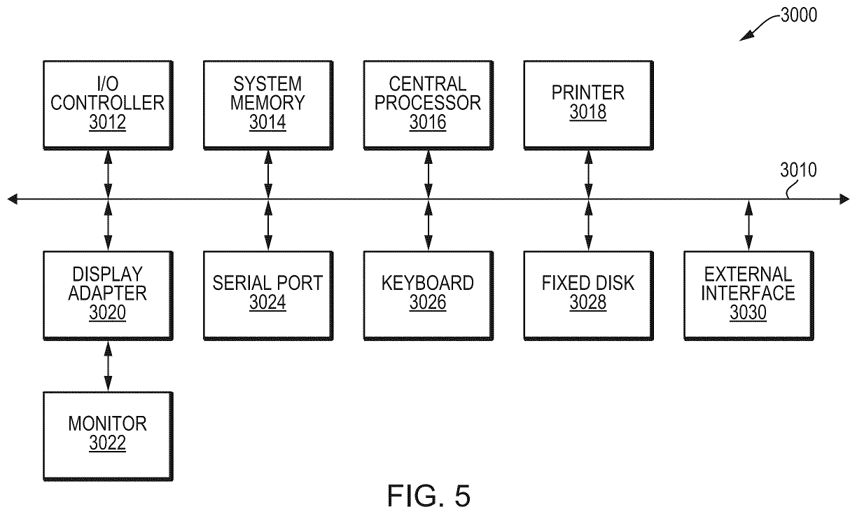

FIG. 5 is a block diagram of a computer apparatus with data processing subsystems or components, according to at least one aspect of the present disclosure.

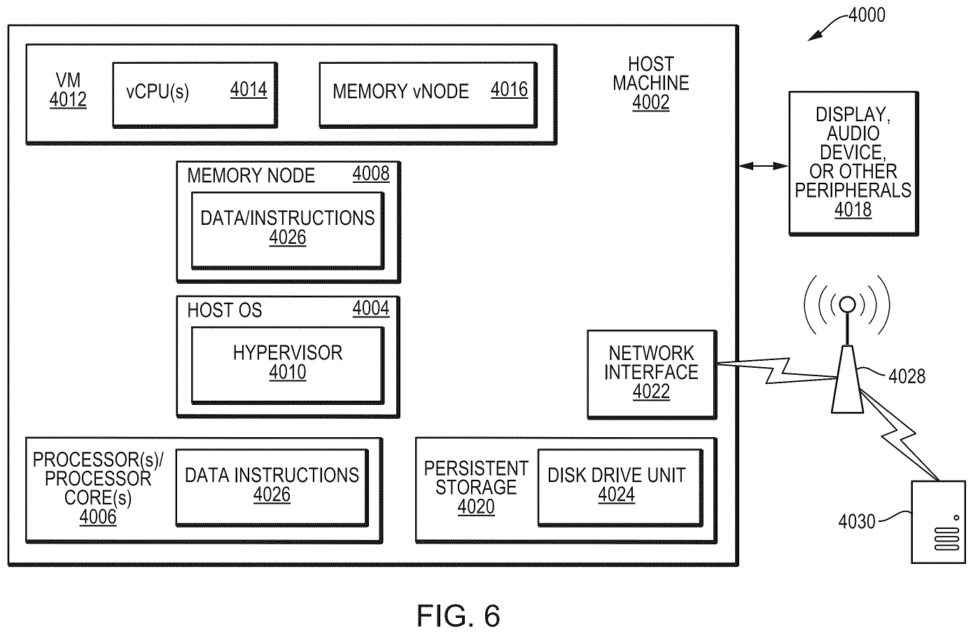

FIG. 6 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

As used herein, the term “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer, or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

The enormity of processing payment transactions is often underestimated in today's digital economy. Each transaction involves a complex web of operations, from authentication to authorization, encryption, and decryption, and settlement. The scale is staggering, with millions of transactions occurring every minute across various platforms globally. Behind the scenes, sophisticated algorithms analyze fraud patterns, while secure networks ensure data integrity and confidentiality, which are taxing, but crucial, functions that consume significant processing resources by each of the entities (i.e., issuer, merchant, acquirer, payment network) involved in a payment transaction. Not aware of the anti-fraud efforts performed by one entity, other entities may repeat such efforts, which may slow down transaction approval time, and waste processing resources.

One prominent example of this issue is in the context of card-not-present transactions, which sets the liability of the non-authenticated transactions on the merchant side. To manage the risk, merchants rely on a set of tools and strategies. The most prominent is the usage of anti-fraud tools like CyberSource Decision Manager. Issuers, on their end, have no visibility on if and which antifraud tool was used by merchants when they receive authorization requests. As such, the issuers will consider such transactions as high-risk transactions, consequently expending unnecessary processing cost to address such transactions.

FIG. 1 illustrates a computer-implemented method 100 for efficiently processing a payment transaction based on shared risk-screening resources. The method 100 facilitates a more efficient payment-transaction processing experience by enabling secure sharing of risk-screening resources. An otherwise high-risk payment transaction is deemed/considered trusted by entities (e.g., issuer 204, payment network 202, acquirer 210) in the transaction processing flow based on risk-screening analyses performed by, or available to, other entities (e.g., merchant 208) in the transaction processing flow.

FIG. 2 illustrates a payment network system 200 to process payment transactions in accordance with the method 100, for example. The payment network system 200 may include the payment network 202, the issuer 204, a transaction risk-screening module 206, the merchant 208, and the acquirer 210, for example. A communication network 212 provides a communications pathway for each of the payment network 202, the issuer 204, the risk-screening module 206, the merchant 208, and the acquirer 210.

Components of the payment network system 200 can be implemented in software, hardware, and/or combinations thereof. Such components may include, or make use of, one or more computer apparatuses, computer systems, or the like. Each of these computer apparatuses, computer servers, computer systems, or the like are described in greater detail below with respect to the computer apparatus 3000 shown in FIG. 5 and computer system 4000 shown in FIG. 6.

FIGS. 3A and 3B illustrates various interactions 300 between components of the payment network system 200 to process payment transactions in accordance with the method 100, for example. The risk-screening module 206 provides an interface between the merchant 208 and the payment network 202. Accordingly, the payment network 202 may receive a transaction authorization request generated by the merchant 208 through the risk-screening module 206.

The risk-screening module 206, which is also referred to herein as a decision manager, may be in communication with one or more merchants 208 to receive 301 transaction information from merchants 208, determine whether to approve 302 such transactions. The risk-screening module 206, in determining whether a transaction is approved 302, may leverage data elements not available to other entities (e.g., issuer 204, payment network 202, acquirer 210) in the transaction processing flow, but available to other entities (e.g., merchants 208). Such data elements may include Contextual data (device fingerprint, IP address), merchant data (positive lists, SKU level information), and/or calculated data (risk scores, velocities, linkages), for example.

In some embodiments, the risk-screening module 206 may communicate with the payment network 202 through the merchant 208. In other embodiments, the merchants may communicate separately with the payment network 202 and the risk-screening module 206.

The method 100 includes receiving 101, by a server, which can be associated with the payment network 202 (FIG. 2), a transmission from the risk-screening module 206 (FIG. 2). The transmission includes a request for an authentication message for a prescreened payment transaction with the merchant 208. The request can indicate that the payment transaction has been screened/approved by the risk-screening module 206, for example.

A preliminary onboarding process can be executed by the payment network 202 to onboard the risk-screening module 206. The on-boarding process may involve merchants 208 or can be performed independently. The preliminary onboarding enables the payment network 202 to trust transmissions received from the risk-screening module 206 based on payment transactions by merchants 208 that are affiliated with an onboarded risk-screening module 206. The preliminary onboarding process can involve implementing an encryption technique such that the transmission is encrypted for security purposes, which ensures a secure communication between the risk-screening module 206 and the payment network 202.

The method 100 further includes generating 102 the authentication message based on the prescreened status of the payment transaction. In at least one aspect, the transmission from the risk-screening module 206 includes an indication that the received authorization request is associated with a prescreened payment transaction. In other aspects, particularly with a previously onboarded risk-screening module 206, it can be presumed that all received transaction information are associated with prescreened payment transactions.

The transmission may include transaction information and/or an identifier associated with the risk-screening module 206, which indicates a previously onboarded/trusted risk-screening module 206 and/or a trusted/prescreened payment transaction. In at least one aspect, the transmission comprises an encrypted message that includes the transaction information and/or the identifier or any other suitable means for indicating a prescreened status of the payment transaction.

Referring to FIGS. 2 and 3A, the transmission may comprise a request 303 for an authentication message (e.g., a cryptogram). The payment network 202 may generate 102 the authentication message in response to receiving the transmission from a trusted risk-screening module 206. Additionally, or alternatively, the payment network 202 may generate 102 the authentication message in response to detecting the identifier and/or the prescreened status in the received transmission.

The authentication message can be in the form of a cryptogram. The cryptogram may comprise transaction data elements, such as the transaction amount, a timestamp, and/or merchant information. Additionally, the cryptogram may include an indication of the trusted/prescreened status of the payment transaction. These elements are processed through a cryptographic function, such as a hash function or an encryption algorithm, to produce the cryptogram.

The payment network 202 may include a cryptogram database 209 that stores encrypted codes generated with each payment transaction. The risk-screening module 206 may request cryptograms for approved payment transactions through a payment network API. The payment network 202 may generate the cryptograms via a cryptogram generator 211 based on transaction data elements, such as the transaction amount, a timestamp, and/or merchant information, and may store the encrypted codes with the cryptogram database 209, for example.

The method 100 further includes transmitting 103 a communication to the risk-screening module 206. The communication includes the authentication message indicative of the prescreened status of the payment transaction. As illustrated in FIG. 3A, the payment network API may generate 304, and return 305, the cryptogram to the risk-screening module 206 with an approval message, based on the prescreened status of the payment transaction. The ability to leverage the processing resources of the risk-screening module 206, by the payment network 202, reduces the processing time and resources required for the payment network 202 to authenticate the payment transaction. Moreover, the payment network 202 is also able to indirectly leverage authentication information available to the risk-screening module 206, but not the payment network 202.

The method 100 further includes receiving 104, from the acquirer 210, the authentication message and an authorization request for the prescreened payment transaction. As illustrated in FIGS. 3A and 3B, the risk-screening module 206 causes the merchant 208 to initiate 306 a payment with the received authentication message. A payment-transaction authorization request is transmitted 307 by the acquirer 210 to the payment network 202 for validation and processing.

The method 100 further includes detecting 105 the prescreened status of the payment transaction. The payment network 202 is to detect 105 the prescreened status of the payment transaction based on the authentication message. In at least one aspect, the authentication message comprises a cryptogram that is decrypted by the payment network 202 for the validation. The authentication message may include a transaction identifier indicative of the prescreened status of the payment transaction. A matching of the transaction identifier may indicate the prescreened status.

The method 100 further includes associating 106 the authorization request with an indicator of the prescreened status of the payment transaction based on the authentication message. As illustrated in FIG. 3B, the payment network 202 may validate 308 the authentication message, and flag the prescreened status of the payment transaction, which is separately determined by the risk-screening module 206. The payment network 202 may update the authorization request to include the indicator of the prescreened status of the payment transaction.

The method 100 may further include transmitting 107, to the issuer 204, the authorization request with the indicator of the prescreened status of the payment transaction, which gives the issuer 204 visibility to the prior risk screening performed by the risk-screening module 206, thereby facilitating a quicker/more efficient processing of the payment transaction. The issuer 204 need not expend precious processing resources to repeat tasks previously performed by the risk-screening module 206.

The method 100 further includes receiving 108, from the issuer 204, an authorization response based on the transmitted authorization request. As illustrated in FIG. 3B, the issuer 204 returns 310 the authorization response to the payment network 202 that forwards 311 the authorization response to the acquirer 210 that, in turn, forwards 312 the authorization response to the merchant 208.

FIG. 4 illustrates a computer-implemented method 400, in accordance with at least one aspect of the present disclosure. The risk-screening module 206 may execute, or at least partially execute, the method 400 in processing a payment transaction by the merchant 208, for example. The method 400 includes receiving 401, by the risk-screening module 206, a risk-evaluation request regarding a payment transaction with the merchant 208.

The merchant 208 may initiate a call through an API of the risk-screening module 206 requesting an evaluation of the risk associated with processing the payment transaction. Simple Object Access Protocol (SOAP) and/or Representational State Transfer (REST) services can be employed. The merchant 208 may transmit, to the risk-screening module 206, transaction data elements such as, for example, payment information, transaction amount, timestamp, merchant information, and/or any other information helpful in risk evaluation.

The method 400 further includes determining 402, by the risk-screening module 206, a risk value associated with the payment transaction, and approving 403, by the risk-screening module, the payment transaction based on the risk value and a corresponding threshold. As illustrated in FIG. 2, the risk-screening module 206 may include a score calculator 205 and a decision maker 207, which can be executed in software, hardware, or combinations thereof. The score calculator 205 may assign a numerical value to transactions based on various risk factors available to the merchant 208. The decision maker 207 may use predefined rules and machine learning algorithms to automatically approve, decline, or flag transactions based on their risk level as determined by the score calculator 205, for example.

The method 400 further includes requesting 404, by the risk-screening module 206, the authentication message from the payment network 202 based on the approving of the payment transaction. Accordingly, if the risk-screening module 206 approves the payment transaction, a request is made the API of the risk-screening module 206, for example, to the payment network 202 to generate the authentication message, as discussed above. The method 400 further includes transmitting 405, by the risk-screening module 206, the authentication message, received from the payment network 202, to the merchant 208 to initiate an authorization request for the payment transaction with the authentication message.

Various aspects of the subject matter described herein are set out in the following examples.

Example 1—A computer-implemented method comprising using a payment network to receive a transmission from a risk-screening module, generate an authentication message based on a prescreened status of the payment network, transmit a communication to the risk-screening module, receive from an acquirer an authorization request for the payment transaction where the authorization request is by the merchant, receive from an acquirer the authentication message, detect the prescreened status of the payment transaction, and associate the authorization request with an indicator of the prescreened status of the payment transaction based on the authentication message. The transmission comprises a request for the authentication message for a payment transaction with a merchant associated with the risk-screening module. The payment transaction comprises the prescreened status. The communication comprises the authentication message. The detecting of the prescreened status of the payment transaction is based on the authentication message.

Example 2—The computer-implemented method of Example 1, further comprising transmitting, to an issuer, the authorization request with the indicator of the prescreened status of the payment transaction.

Example 3—The computer-implemented method of Example 2, further comprising receiving, by the payment network, from the issuer, an authorization response based on the transmitted authorization request.

Example 4—The computer-implemented method of any one of Examples 1-3, wherein the authorization request comprises at least one of payment information, merchant information, or merchant information.

Example 5—The computer-implemented method of any one of Examples 1-4, wherein the generating of the authentication message comprises encrypting transaction information received in the transmission.

Example 6—The computer-implemented method of Example 5, wherein the transaction information comprises at least one of a transaction identifier, a transaction amount, or a time stamp.

Example 7—The computer-implemented method of any one of Examples 1-6, wherein the detecting of the prescreened status of the payment transaction comprises validating the authentication message.

Example 8—The computer-implemented method of any one of Examples 1-7, wherein the authentication message comprises a cryptogram, and wherein the detecting of the prescreened status of the payment transaction comprises decrypting the cryptogram.

Example 9—The computer-implemented method of any one of Examples 1-8, wherein the associating of the authorization request with the indicator comprises updating the authorization request to include the indicator.

Example 10—A computer-implemented method comprising using a risk-screening module to receive a risk-evaluation request regarding a payment transaction with a merchant, determine a risk value associated with the payment transaction, approve the payment transaction based on the risk value and a corresponding threshold, transmit to the merchant the approval of the payment transaction, request an authentication message from a payment network based on the approving of the payment transaction, and transmit the authentication message to the merchant to initiate an authorization request for the payment transaction with the authentication message.

Example 11—The computer-implemented method of Example 10, wherein the authentication message comprises encrypted transaction information.

Example 12—The computer-implemented method of Example 11, wherein the encrypted transaction information comprises a transaction identifier, a transaction amount, or a time stamp.

Example 13—The computer-implemented method of any one of Examples 10-12, wherein the corresponding threshold is a predetermined threshold.

Example 14—A transaction risk-screening system comprising a payment network. The payment network comprises a cryptogram database, a cryptogram generator, and an application programming interface (API). The payment network is to receive a transmission from a risk-screening module, generate a cryptogram based on a prescreened status of the payment transaction, store the cryptogram in the cryptogram database, transmit a communication to the risk-screening module, receive from an acquirer an authorization request for the payment transaction where the authorization request is by the merchant, receive from an acquirer the cryptogram, validate the cryptogram based on the cryptogram database to identify the prescreened status of the payment transaction, and flag the authorization request to indicate the prescreened status of the payment transaction. The receiving of the transmission occurs via the API. The transmission comprises a request for a cryptogram for a payment transaction with a merchant associated with the risk-screening module. The payment transaction comprises a prescreened status. The generation of the cryptogram occurs by the cryptogram generator. The transmission of the communication occurs via the API. The communication comprises the cryptogram. The receipt from the acquirer occurs by the payment network.

Example 15—The transaction risk-screening system of Example 14, wherein the payment network is to transmit, to an issuer, the flagged authorization request.

Example 16—The transaction risk-screening system of Example 14 or 15, wherein the payment network is to receive, from the issuer, an authorization response based on the transmitted authorization request.

Example 17—The transaction risk-screening system of any one of Examples 14-16, wherein the authorization request comprises at least one of payment information, merchant information, or merchant information.

Example 18—The transaction risk-screening system of any one of Examples 14-17, wherein the cryptogram comprises encrypted transaction information.

Example 19—The transaction risk-screening system of Example 18, wherein the encrypted transaction information comprises at least one of a transaction identifier, a transaction amount, or a time stamp.

An “acquirer”, as used herein, may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

A “cryptographic algorithm” can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc. Encryption techniques may include symmetric and asymmetric encryption techniques.

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer”, “issuer system”, or “issuer institution system” may refer to one or more systems operated by or operated on behalf of an issuer. For example, an issuer may refer to a server executing one or more software applications associated with the issuer. In some non-limiting embodiments or aspects, an issuer may include one or more servers (e.g., one or more authorization servers) for authorizing a payment transaction.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant” may refer to one or more computer systems operated by or on behalf of a merchant, such as a server computer executing one or more software applications.

The systems and methods, as described above with respect to each of FIGS. 1-4, may include, or make use of, a number of computer apparatuses, computer systems, or the like. In other words, to utilize the systems and methods disclosed herein, at least one of a computer apparatus, computer system, or the like may be implemented. Each of these computer apparatuses, computer systems, or the like are described in greater detail below with respect to the computer apparatus 3000 shown in FIG. 5 and the example system 4000 shown in FIG. 6, which provide a connection between the solution disclosed herein and how such a solution may be implemented within a business entity, such as a payment network, a processing network, a payment processing network, or the like.

FIG. 5 is a block diagram of a computer apparatus 3000 with data processing subsystems or components, according to at least one aspect of the present disclosure. The subsystems shown in FIG. 6 are interconnected via a system bus 3010. Additional subsystems such as a printer 3018, keyboard 3026, fixed disk 3028 (or other memory comprising computer-readable media), monitor 3022 (which is coupled to a display adapter 3020), and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus 3010 allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer-readable medium.

FIG. 6 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a stand-alone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC); a tablet PC; a set-top box; a personal digital assistant; a cellular telephone; a portable music player (e.g., a portable hard drive audio device, such as an Moving Picture Experts Group Audio Layer 3 (MP3) player); a web appliance; a network router, switch, or bridge; or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit, or both), and various memory nodes 4008. The host OS 4004 may include a hypervisor 4010, which is able to control the functions and/or communicate with a virtual machine (VM) 4012 running on machine-readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other or communicate to each other via a bus (not shown) or via other coupling or communication channels or mechanisms. The host machine 4002 may further include a video display, audio device, or other peripherals 4018 (e.g., a liquid crystal display; alpha-numeric input device(s) including, e.g., a keyboard; a cursor control device, e.g., a mouse; a voice recognition or biometric verification unit; an external drive; a signal generation device, e.g., a speaker); a persistent storage device 4020 (also referred to as disk drive unit); and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various OSs may be used, including UNIX, LINUX, WINDOWS, QNX ANDROID, IOS, CHROME, TIZEN, and other suitable OSs.

The disk drive unit 4024 also may be a solid-state drive, a hard disk drive, or other drive that includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read-only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service and that the computing devices may include one or more processors, buses, memory devices, display devices, I/O devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

Suitable networks may include or interface with any one or more of, for instance, a local intranet; a personal area network (PAN); a local area network (LAN); a wide area network (WAN); a metropolitan area network (MAN); a virtual private network (VPN); a storage area network (SAN); a frame relay connection; an advanced intelligent network (AlN) connection; a synchronous optical network (SONET) connection; a digital T1, T3, E1, or E3 line; a digital data service (DDS) connection; a digital subscriber line (DSL) connection; an Ethernet connection; an integrated services digital network (ISDN) line; a dial-up port, such as a V.90, V.34, or V.34bis analog modem connection; a cable modem; an Asynchronous Transfer Mode (ATM) connection; or an Fiber Distributed Data Interface (FDDI) or Copper Distributed Data Interface (CDDI) connection. Furthermore, communications may also include links to any of a variety of wireless networks, including Wireless Application Protocol (WAP), General Packet Radio Service (GPRS), Global System for Mobile Communication (GSM), Code Division Multiple Access (CDMA) or Time Division Multiple Access (TDMA), cellular phone networks, global positioning system (GPS), cellular digital packet data (CDPD), Research in Motion, Limited (RIM) duplex paging network, Bluetooth radio, or an Institute of Electrical and Electronics Engineers (IEEE) 802.11-based radio frequency (RF) network. The network 4028 can further include or interface with any one or more of an RS-232 serial connection, an IEEE-1394 (Firewire) connection, a Fiber Channel connection, an IrDA (infrared (IR)) port, a Small Computer Systems Interface (SCSI) connection, a Universal Serial Bus (USB) connection or other wired or wireless, digital, or analog interface or connection, mesh, or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during RF and IR data communications. Common forms of computer-readable media include, for example, a flexible disk, a hard disk, magnetic tape, any other magnetic medium, a compact disc ROM (CD-ROM) disk, digital video disc, any other optical medium, any other physical medium with patterns of marks or holes, a RAM, a programmable ROM, an erasable programmable ROM (EPROM), an electrically erasable programmable ROM (EEPROM), a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a LAN or a WAN, or the connection may be made to an external computer (for example, through the Internet using an Internet service provider).

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, those skilled in the art will appreciate that the mechanisms of the subject matter described herein are capable of being distributed as one or more program products in a variety of forms, and an illustrative form of the subject matter described herein applies regardless of the particular type of signal-bearing medium used to actually carry out the distribution.

Instructions used to program logic to perform various disclosed aspects can be stored within a memory in the system, such as dynamic RAM, cache, flash memory, or other storage. Furthermore, the instructions can be distributed via a network or by way of other computer-readable media. Thus a machine-readable medium may include any mechanism for storing or transmitting information in a form readable by a machine (e.g., a computer), including, but not limited to, floppy diskettes, optical disks, CD-ROMs, magneto-optical disks, ROM, RAM, EPROM, EEPROM, magnetic or optical cards, flash memory, or a tangible, machine-readable storage used in the transmission of information over the Internet via electrical, optical, acoustical, or other forms of propagated signals (e.g., carrier waves, IR signals, digital signals). Accordingly, the non-transitory computer-readable medium includes any type of tangible machine-readable medium suitable for storing or transmitting electronic instructions or information in a form readable by a machine (e.g., a computer).

Any of the software components or functions described in this application may be implemented as software code to be executed by a processor using any suitable computer language, such as, for example, Python, Java, C++, or Perl, using, for example, conventional or object-oriented techniques. The software code may be stored as a series of instructions or commands on a computer-readable medium, such as RAM, ROM, a magnetic medium such as a hard drive or a floppy disk, or an optical medium such as a CD-ROM. Any such computer-readable medium may reside on or within a single computational apparatus and may be present on or within different computational apparatuses within a system or network.

As used in any aspect herein, the term “logic” may refer to an app, software, firmware, and/or circuitry configured to perform any of the aforementioned operations. Software may be embodied as a software package, code, instructions, instruction sets, and/or data recorded on a non-transitory computer-readable storage medium. Firmware may be embodied as code, instructions, instruction sets, and/or data that are hard-coded (e.g., non-volatile) in memory devices.

As used in any aspect herein, the terms “component,” “system,” “module,” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states that may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet-switched network. The communication devices may be capable of communicating with each other using a selected packet-switched network communications protocol. One example communications protocol may include an Ethernet communications protocol, which may be capable of permitting communication using a Transmission Control Protocol/Internet Protocol. The Ethernet protocol may comply or be compatible with the Ethernet standard published by the IEEE titled “IEEE 802.3 Standard,” published in December 2008 and/or later versions of this standard. Alternatively, or additionally, the communication devices may be capable of communicating with each other using an X.25 communications protocol. The X.25 communications protocol may comply or be compatible with a standard promulgated by the International Telecommunication Union-Telecommunication Standardization Sector. Alternatively, or additionally, the communication devices may be capable of communicating with each other using a frame relay communications protocol. The frame relay communications protocol may comply or be compatible with a standard promulgated by Consultative Committee for International Telegraph and Telephone and/or the American National Standards Institute. Alternatively, or additionally, the transceivers may be capable of communicating with each other using the ATM communications protocol. The ATM communications protocol may comply or be compatible with an ATM standard published by the ATM Forum titled “ATM-MPLS Network Interworking 2.0,” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like refer to the action and processes of a computer system, or similar electronic computing device, that manipulates and transforms data represented as physical (electronic) quantities within the computer system's registers and memories into other data similarly represented as physical quantities within the computer system memories, registers, or other such information storage, transmission, or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including, but not limited to”; the term “having” should be interpreted as “having at least”; the term “includes” should be interpreted as “includes, but is not limited to”). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general, such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together). In those instances where a convention analogous to “at least one of A, B, or C, etc.” is used, in general, such a construction is intended in the sense one having skill in the art would understand the convention (e.g., “a system having at least one of A, B, or C” would include, but not be limited to, systems that have A alone, B alone, C alone, A and B together, A and C together, B and C together, and/or A, B, and C together). It will be further understood by those skilled in the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A,” “B,” or “A and B.”

With respect to the appended claims, those skilled in the art will appreciate that recited operations therein may generally be performed in any order. Also, although various operational flow diagrams are presented in sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the features, structures, or characteristics may be combined in any suitable manner in one or more aspects.

As used herein, the singular form of “a,” “an,” and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated material is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material. None is admitted to be prior art.

In summary, numerous benefits have been described that result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described to illustrate principles and practical application to thereby enable one of ordinary skill in the art to utilize the various forms with various modifications as are suited to the particular use contemplated. It is intended that the claims submitted herewith define the overall scope.

What is claimed is:

1. A computer-implemented method, comprising:
receiving, by a payment network, a transmission from a risk-screening module, the transmission comprising a request for an authentication message for a payment transaction with a merchant associated with the risk-screening module, the payment transaction comprising a prescreened status;
generating, by the payment network, the authentication message based on the prescreened status of the payment transaction;
transmitting, by the payment network, a communication to the risk-screening module, the communication comprising the authentication message;
receiving, by the payment network, from an acquirer:
an authorization request for the payment transaction, the authorization request by the merchant, and
the authentication message;
detecting, by the payment network, the prescreened status of the payment transaction, wherein the detecting of the prescreened status of the payment transaction is based on the authentication message; and
associating, by the payment network, the authorization request with an indicator of the prescreened status of the payment transaction based on the authentication message.

2. The computer-implemented method of claim 1, further comprising transmitting, to an issuer, the authorization request with the indicator of the prescreened status of the payment transaction.

3. The computer-implemented method of claim 2, further comprising receiving, by the payment network, from the issuer, an authorization response based on the transmitted authorization request.

4. The computer-implemented method of claim 1, wherein the authorization request comprises at least one of payment information, merchant information, or merchant information.

5. The computer-implemented method of claim 1, wherein the generating of the authentication message comprises encrypting transaction information received in the transmission.

6. The computer-implemented method of claim 5, wherein the transaction information comprises at least one of a transaction identifier, a transaction amount, or a time stamp.

7. The computer-implemented method of claim 1, wherein the detecting of the prescreened status of the payment transaction comprises validating the authentication message.

8. The computer-implemented method of claim 1, wherein the authentication message comprises a cryptogram, and wherein the detecting of the prescreened status of the payment transaction comprises decrypting the cryptogram.

9. The computer-implemented method of claim 1, wherein the associating of the authorization request with the indicator comprises updating the authorization request to include the indicator.

10. A computer-implemented method, comprising:
receiving, by a risk-screening module, a risk-evaluation request regarding a payment transaction with a merchant;
determining, by the risk-screening module, a risk value associated with the payment transaction;
approving, by the risk-screening module, the payment transaction based on the risk value and a corresponding threshold;
transmitting, by the risk-screening module, to the merchant, the approval of the payment transaction;
requesting, by the risk-screening module, an authentication message from a payment network based on the approving of the payment transaction; and
transmitting, by the risk-screening module, the authentication message to the merchant to initiate an authorization request for the payment transaction with the authentication message.

11. The computer-implemented method of claim 10, wherein the authentication message comprises encrypted transaction information.

12. The computer-implemented method of claim 11, wherein the encrypted transaction information comprises a transaction identifier, a transaction amount, or a time stamp.

13. The computer-implemented method of claim 10, wherein the corresponding threshold is a predetermined threshold.

14. A transaction risk-screening system, comprising:
a payment network, comprising:
a cryptogram database;
a cryptogram generator; and
an application programming interface (API), wherein the payment network is to:
receive, via the API, a transmission from a risk-screening module, the transmission comprising a request for a cryptogram for a payment transaction with a merchant associated with the risk-screening module, the payment transaction comprising a prescreened status;
generate, by the cryptogram generator, the cryptogram based on the prescreened status of the payment transaction;
store the cryptogram in the cryptogram database;
transmit, via the API, a communication to the risk-screening module, the communication comprising the cryptogram;
receive, by the payment network, from an acquirer:
an authorization request for the payment transaction, the authorization request by the merchant, and
the cryptogram;
validate the cryptogram based on the cryptogram database to identify the prescreened status of the payment transaction; and
flag the authorization request to indicate the prescreened status of the payment transaction.

15. The transaction risk-screening system of claim 14, wherein the payment network is to transmit, to an issuer, the flagged authorization request.

16. The transaction risk-screening system of claim 15, wherein the payment network is to receive, from the issuer, an authorization response based on the transmitted authorization request.

17. The transaction risk-screening system of claim 14, wherein the authorization request comprises at least one of payment information, merchant information, or merchant information.

18. The transaction risk-screening system of claim 14, wherein the cryptogram comprises encrypted transaction information.

19. The transaction risk-screening system of claim 18, wherein the encrypted transaction information comprises at least one of a transaction identifier, a transaction amount, or a time stamp.
